(19) United States
(12) Patent Application Publication
(10) Pub. No.: US 2013/0139532 A1
(43) Pub. Date: Jun. 6, 2013

(54) AIR CONDITIONER FOR VEHICLE

(71) Applicants: Hideki Hashigaya, Shizuoka (JP); Isamu Ito, Shizuoka (JP); Yuki Futsuhara, Shizuoka (JP); Yorisada Kondo, Shizuoka (JP)

(72) Inventors: Hideki Hashigaya, Shizuoka (JP); Isamu Ito, Shizuoka (JP); Yuki Futsuhara, Shizuoka (JP); Yorisada Kondo, Shizuoka (JP)

(73) Assignee: SUZUKI MOTOR CORPORATION, Hamamatsu-shi, Shizuoka (JP)

(21) Appl. No.: 13/699,606

(22) PCT Filed: Apr. 19, 2011
(86) PCT No.: PCT/JP2011/059630

§ 371 Date: Feb. 11, 2013

(30) Foreign Application Priority Data
May 24, 2010 (JP) 2010-118153

(51) Int. Cl. B60H 1/00

(52) U.S. Cl. CPC B60H 1/00428
USPC 62/134

(57) ABSTRACT

A controlling unit includes a fan air supply amount setting unit communicated with a supply fan feeding air cooled by an electric compressor into an interior of a vehicle and setting an air supply amount of the supply fan, and sets a rotation speed upper limit value of the electric compressor based on a vehicle speed detected by a vehicle speed detecting unit and the air supply amount set by the fan air supply amount setting unit.

### TECHNICAL FIELD

The present invention relates to an air conditioner for a vehicle, and in particular to an air conditioner for a vehicle controlling the electric compressor of an air conditioner mounted on the vehicle such as an electric vehicle and a hybrid vehicle.

### BACKGROUND ART

In recent years, vehicles taking environmental consideration such as an electric vehicle (EV) and a hybrid vehicle (HEV) have been focused. A motor driving the vehicle is mounted and an air conditioner including an electric compressor is mounted on the environmental consideration vehicles.

The vehicles such as the electric vehicle and the hybrid vehicle are able to drive without any noise owing to driving of the motor and so on, and therefore, there is a case when an operation noise of the electric compressor makes a passenger feel uncomfortable in a region where the vehicle speed is low and when the vehicle stops.

### CITATION LIST

### Patent Literature

Patent Literature 1: Japanese Laid-open
Patent Publication No. 07-223428
Patent Literature 2: Japanese Laid-open Patent Publication No. 04-169322

An air conditioner for an electric vehicle according to Patent Literature 1 suppresses generation of noise by performing an air conditioning operation in accordance with a set output of an air conditioning control by controlling a rotation speed of the electric compressor.

A control method of an air conditioner for an electric vehicle according to Patent Literature 2 is to control such that a maximum value of an operation frequency of an electric compressor gradually increases as a vehicle speed increases.

### SUMMARY OF INVENTION

### Technical Problem

Incidentally, a method limiting a rotation speed of an electric compressor to a certain rotation speed or less in accordance with a vehicle speed is conventionally considered to reduce generation of noise in an air conditioner for a vehicle controlling the electric compressor. In this case, a limited rotation speed of the electric compressor (hereinafter, referred to as a “rotation speed upper limit value”) is determined regardless of a degree of effect of an air conditioning. Accordingly, there is a problem in which the rotation speed upper limit value can be lowered under a state in which the air conditioning is fully in effect and so on, but the electric compressor operates in vain to increase power consumption. On the other hand, the rotation speed upper limit value of the electric compressor is determined by the vehicle speed even when the air conditioning is not fully in effect, and therefore, there is a problem in which cooling cannot be turned up with respect to a user's request.

An object of the present invention is to provide an air conditioner for a vehicle enabling a reduction in noise of the electric compressor and a reduction in power consumption of the electric compressor.

### Solution to Problem

The present invention is an air conditioner for a vehicle mounting a motor driving the vehicle, including: a vehicle speed detecting unit detecting a speed of the vehicle; an electric compressor used for cooling of an interior of the vehicle; a compressor rotation speed controlling unit controlling a rotation speed of the electric compressor; a supply fan feeding air cooled by the electric compressor into the interior of the vehicle; a fan air supply amount setting unit setting an air supply amount of the supply fan; and a controlling unit setting a rotation speed upper limit value of the electric compressor controlled by the compressor rotation speed controlling unit when the vehicle speed detected by the vehicle speed detecting unit is a predetermined speed or less, wherein the controlling unit sets the rotation speed upper limit value of the electric compressor based on the vehicle speed detected by the vehicle speed detecting unit and the air supply amount set by the fan air supply amount setting unit.

### Advantageous Effects of Invention

In general, a vehicle generates noise by a driving. A volume of this noise changes in accordance with a driving state of the vehicle. Namely, the noise according to the driving state of the vehicle becomes large as a vehicle speed increases. Otherwise, the noise according to the driving state of the vehicle becomes large as an engine speed becomes large. The air conditioner for the vehicle according to the present invention enables the reduction in the noise of the electric compressor and the reduction in the power consumption of the electric compressor by making the noise according to the driving state of the vehicle small and making the rotation speed upper limit value of the electric compressor low when an air supply amount into an interior of the vehicle is small.

### BRIEF DESCRIPTION OF DRAWINGS

FIG. 1 is a system configuration chart of an air conditioner for a vehicle. (Example 1)

FIG. 2 is a two-dimensional matrix map setting a rotation speed upper limit value of an electric compressor. (Example 1)

FIG. 3 is a two-dimensional matrix map setting a rotation speed upper limit value of an electric compressor. (Example 2)

FIG. 4 is a map calculating a rotation speed upper limit value (temporary) of the electric compressor according to a vehicle speed. (Example 2)

FIG. 5 is a map calculating a constant of a rotation speed of the electric compressor according to an air supply amount into an interior of the vehicle. (Example 2)

FIG. 6 is a flowchart calculating the rotation speed upper limit value of the electric compressor by adding the constant of the rotation speed of the electric compressor according to the air supply amount into the interior of the vehicle to the rotation speed upper limit value (temporary) of the electric compressor according to the vehicle speed. (Example 2)

FIG. 7 is a two-dimensional matrix map setting a rotation speed upper limit value of an electric compressor. (Example 3)

FIG. 8 is a map of a rotation speed upper limit value (temporary) of the electric compressor according to the vehicle speed. (Example 3)

FIG. 9 is a map of a coefficient of the rotation speed of the electric compressor according to the air supply amount into the interior of the vehicle. (Example 3)

FIG. 10 is a flowchart calculating the rotation speed upper limit value of the electric compressor by multiplying the coefficient of the rotation speed of the electric compressor according to the air supply amount into the interior of the vehicle with the rotation speed upper limit value (temporary) of the electric compressor according to the vehicle speed. (Example 3)

### DESCRIPTION OF EMBODIMENTS

The present invention attains objects enabling a reduction in noise of an electric compressor and a reduction in power consumption of the electric compressor by lowering a rotation speed upper limit value of the electric compressor when the noise according to a driving state of a vehicle is small and an air supply amount into an interior of the vehicle is small.

### Example 1

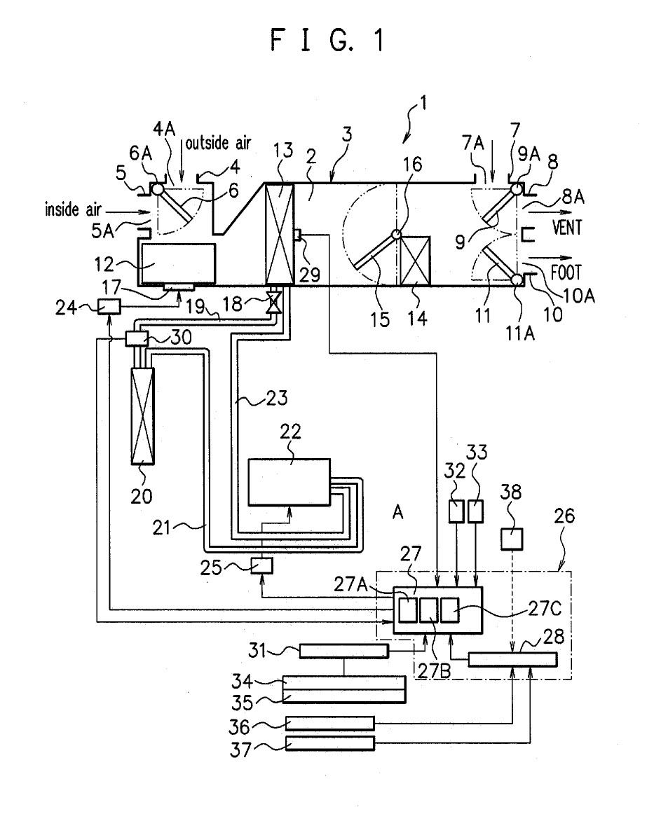

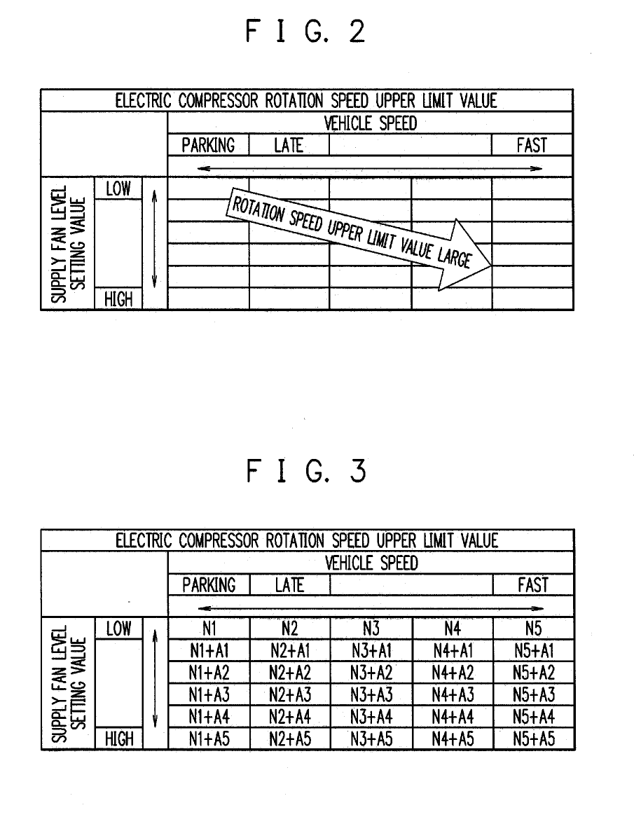

FIG. 1 and FIG. 2 illustrate an example 1 of the present invention.

In FIG. 1, a reference numeral 1 represents an air conditioner (HVAC unit) mounted on a vehicle including a motor such as an electric vehicle (EV) and a hybrid vehicle (HEV). The air conditioner 1 includes a passage forming member 3 forming an airflow passage 2.

A base part 6A of an inside/outside air switching damper 6, a base part 9A of a blowout port switching damper 9 and a base part 11A of an opening/closing damper 11 are provided at the passage forming member 3. The inside/outside air switching damper 6 swings toward inside at one end to be an upstream side to switch between an outside air inlet 4A to which an outside air inlet duct 4 is connected and an inside air inlet 5A to which an inside air inlet duct 5 is connected. The blowout port switching damper 9 swings toward inside at the other end to be a downstream side to switch between a defroster blowout port 7A connected to a defroster duct 7 and a vent blowout port 8A connected to a vent duct 8. The opening/closing damper 11 swings toward inside at the other end to open/close a foot blowout port 10A connected to a foot duct 10.

Besides, a supply fan 12 at a direct downstream side of the inside/outside air switching damper 6, an evaporator 13 at a downstream side than the supply fan 12, a heater core 14 at the downstream side than the evaporator 13, and a pivot shaft 16 of an air mix damper 15 swinging in the airflow passage 2 to adjust an air flow rate to the heater core 14 are included in the passage forming member 3.

The supply fan 12 includes a fan motor 17 driving the supply fan 12, and feeds the air cooled by a later-described electric compressor 22 into the interior of the vehicle.

One end of a first refrigerant high pressure pipe 19 including an expansion valve 18 is connected to the evaporator 13. The other end of the first refrigerant high pressure pipe 19 is connected to a condenser 20.

One end of a second refrigerant high pressure pipe 21 is connected to the condenser 20. The other end of the second refrigerant high pressure pipe 21 is connected to the electric compressor 22 driven by electricity and used for the cooling of the interior of the vehicle.

One end of a refrigerant low pressure pipe 23 is connected to the electric compressor 22. The other end of the refrigerant low pressure pipe 23 is connected to the evaporator 13.

Besides, a fan motor driving unit 24 driving the fan motor 17 and a compressor driving unit 25 driving the electric compressor 22 are included in the air conditioner 1.

The fan motor driving unit 24 and the compressor driving unit 25 are communicated with a controlling unit 26.

The controlling unit 26 is made up of an air conditioning controlling unit (ECU) 27 communicated with the fan motor driving unit 24 and the compressor driving unit 25, and a vehicle controlling unit (ECU) 28 communicated with the air conditioning controlling unit 27.

An evaporator temperature detecting unit 29 detecting a temperature of the evaporator 13, a refrigerant pressure detecting unit 30 provided at the first refrigerant high pressure pipe 19 and detecting a pressure of a refrigerant, an air conditioning operation panel 31, a noise detecting unit 32 directly detecting a volume of noise, and a fan motor rotation speed detecting unit 33 detecting a rotation speed of the fan motor 17 are communicated with the air conditioning controlling unit 27.

The air conditioning operation panel 31 is used when the air conditioner 1 is manually operated by a user, switches such as a supply fan level setting switch 34 determining a rotation level of the fan motor 17, an supply air temperature setting switch 35 are provided thereto, and a user's air conditioning request is determined by a fan level setting value of the supply fan level setting switch 34.

Note that the determination of the user's air conditioning request is able to be performed not by the fan level setting value of the supply fan level setting switch 34 but by the rotation speed of the fan motor 17 detected by the fan motor rotation speed detecting unit 33, or by an actual rotation level of the fan motor 17 determined by the fan level setting value. In this case, the air conditioner 1 is able to automatically adjust the air conditioning as an automatic air conditioner.

Besides, an outside air temperature detecting unit 36 detecting an outside air temperature, a vehicle speed detecting unit 37 detecting a vehicle speed, and an engine speed detecting unit 38 detecting an engine speed when the vehicle is the hybrid vehicle (HEV) are communicated with the vehicle controlling unit 28.

The air conditioning controlling unit 27 includes a compressor rotation speed controlling unit 27A controlling the rotation speed of the electric compressor 22 and sets the rotation speed upper limit value (limited rotation speed) of the electric compressor 22 controlled by the compressor rotation speed controlling unit 27A when the vehicle speed detected by the vehicle speed detecting unit 37 is a predetermined speed or less.

Besides, the air conditioning controlling unit 27 includes a fan air supply amount setting unit 27B setting an air supply amount of the supply fan 12, and sets the rotation speed upper limit value of the electric compressor 22 based on the vehicle speed detected by the vehicle speed detecting unit 37 and the air supply amount set by the fan air supply amount setting unit 27B.

For example, the rotation speed upper limit values of the electric compressor 22 (for example, 30 ways) are determined by a two-dimensional matrix while using two of the vehicle speed (for example, five levels of the vehicle speed) and the user's air conditioning request (for example, six levels of the fan level setting values of the air conditioning operation panel 31) as parameters, as illustrated in FIG. 2. Namely, the rotation speed upper limit value of the electric compressor 22 is set large as the vehicle speed becomes faster (noise is large) and as the fan level setting value becomes higher.

Note that it is possible to determine the rotation speed upper limit value by a value of the engine speed detected by the engine speed detecting unit 38 in case of the hybrid vehicle (HEV).

It is thereby possible to set the rotation speed upper limit value of the electric compressor 22 low when the noise according to the driving state of the vehicle is small (during stopping, low-speed driving), and the air supply amount into the interior of the vehicle is small (when the fan level setting value is low at the air conditioning operation panel 31, and therefore, the air conditioning request is low), and the reduction in the noise of the electric compressor 22 and the reduction in the power consumption of the electric compressor 22 are enabled.

Besides, when the noise according to the driving state of the vehicle is small (during stopping, low-speed driving) and the air supply amount into the interior of the vehicle is large (the fan level setting value is high at the air conditioning operation panel 31, and therefore, the air conditioning request is high), the rotation speed upper limit value of the electric compressor 22 is set high, and therefore, it is possible to increase the effect of the cooling. Besides, the noise of the electric compressor 22 is canceled by the noise of the supply fan 12, and therefore, it is possible not to make the passenger feel uncomfortable caused by the noise of the electric compressor 22.

Further, the rotation speed upper limit value of the electric compressor 22 increases/decreases in accordance with the fan level setting value at the air conditioning operation panel 31 when the noise according to the driving state of the vehicle is large (during the vehicle is in high speed driving). The noise of the electric compressor 22 is canceled by the noise according to the driving, and therefore, it is possible not to make the passenger feel uncomfortable caused by the noise of the electric compressor 22. Besides, the control of the electric compressor 22 enabling both the effect of the cooling and the reduction in the power consumption becomes possible.

Further, each component of the air conditioner 1 is included in a normal vehicle, and therefore, the control is enabled in low-cost while simplifying a configuration without adding a new component.

Besides, it is possible for the air conditioning controlling unit 27 to set the rotation speed upper limit value of the electric compressor 22 based on not the vehicle speed detected by the vehicle speed detecting unit 37 but the volume of the noise detected by the noise detecting unit 32 and the air supply amount set by the fan air supply amount setting unit 27B.

It is thereby possible to detect the noise which has no relation to the driving state of the vehicle, and therefore, the control taking along with a current state becomes possible. For example, when the noise around the vehicle is large and the air supply amount into the interior of the vehicle is large even though the vehicle stops, the rotation speed upper limit value of the electric compressor 22 is set high as same as during driving, and therefore, it becomes possible to increase the effect of the cooling.

Further, the air conditioning controlling unit 27 includes a fan motor rotation speed controlling unit 27C controlling the rotation speed of the fan motor 17 driving the supply fan 12, and the rotation speed upper limit value of the electric compressor 22 can be set based on not the air supply amount set by the fan air supply amount setting unit 27B but the vehicle speed detected by the vehicle speed detecting unit 37 or the volume of the noise detected by the noise detecting unit 32, and the rotation speed of the fan motor 17 controlled by the fan motor rotation speed controlling unit 27C.

It is thereby possible to set the rotation speed upper limit value of the electric compressor 22 low when the noise according to the driving state of the vehicle is small (during stopping, low-speed driving), and the air supply amount into the interior of the vehicle is small (when the fan level setting value is low at the air conditioning operation panel 31, and therefore, the air conditioning request is low). Accordingly, the reduction in the noise of the electric compressor 22 and the reduction in the power consumption of the electric compressor 22 are enabled.

Besides, it becomes possible to increase the effect of the cooling because the rotation speed upper limit value of the electric compressor 22 is set high when the noise according to the driving state of the vehicle is small (during stopping, low-speed driving), and the air supply amount into the interior of the vehicle is large (when the fan level setting value is high at the air conditioning operation panel 31, and therefore, the air conditioning request is high). Besides, the noise of the electric compressor 22 is canceled by the noise of the supply fan 12, and therefore, it is possible not to make the passenger feel uncomfortable caused by the noise of the electric compressor 22.

Further, the rotation speed upper limit value of the electric compressor 22 increases/decreases in accordance with the fan level setting value at the air conditioning operation panel 31 when the noise according to the driving state of the vehicle is large (during the vehicle is in high-speed driving). The noise of the electric compressor 22 is canceled by the noise according to the driving, and therefore, it is possible not to make the passenger feel uncomfortable caused by the noise of the electric compressor 22. Besides, the control of the electric compressor 22 enabling both the effect of the cooling and the reduction in the power consumption becomes possible.

Further, each component of the air conditioner 1 other than the noise detecting unit is included in a normal vehicle, and therefore, the control is enabled in low-cost while simplifying a configuration without adding a new component.

Besides, it is possible to detect the noise which has no relation to the driving state of the vehicle, and therefore, the control taking along with a current state becomes possible. For example, when the noise around the vehicle is large and the air supply amount into the interior of the vehicle is large even though the vehicle stops, the rotation speed upper limit value of the electric compressor 22 is set high as same as during driving, and therefore, it becomes possible to increase the effect of the cooling.

Further, the air conditioning controlling unit 27 is able to set the rotation speed upper limit value of the electric compressor 22 based on not the air supply amount set by the fan air supply amount setting unit 27B but the vehicle speed detected by the vehicle speed detecting unit 37 or the volume of the noise detected by the noise detecting unit 32, and the rotation speed of the fan motor 17 detected by the fan motor rotation speed detecting unit 33.

It is thereby possible to set the rotation speed upper limit value of the electric compressor 22 low when the noise according to the driving state of the vehicle is small (during stopping, low-speed driving), and the air supply amount into the interior of the vehicle is small (when the fan level setting value is low at the air conditioning operation panel 31, and therefore, the air conditioning request is low), and the reduction in the noise of the electric compressor 22 and the reduction in the power consumption of the electric compressor 22 become possible.

Besides, it becomes possible to increase the effect of the cooling because the rotation upper limit value of the electric compressor 22 is set high when the noise according to the driving state of the vehicle is small (during stopping, low-speed driving), and the air supply amount into the interior of the vehicle is large (when the fan level setting value is high at the air conditioning operation panel 31, and therefore, the air conditioning request is high). Besides, the noise of the electric compressor 22 is canceled by the noise of the supply fan 12, and therefore, it is possible not to make the passenger feel uncomfortable caused by the noise of the electric compressor 22.

Further, the rotation speed upper limit value of the electric compressor 22 increases/decreases in accordance with the fan level setting value at the air conditioning operation panel 31 when the noise according to the driving state of the vehicle is large (during the vehicle is in high-speed driving). The noise of the electric compressor 22 is canceled by the noise according to the driving, and therefore, it is possible not to make the passenger feel uncomfortable caused by the noise of the electric compressor 22. Besides, the control of the electric compressor 22 enabling both the effect of the cooling and the reduction in the power consumption becomes possible.

Further, each component of the air conditioner 1 other than the noise detecting unit is included in a normal vehicle, and therefore, the control is enabled in low-cost while simplifying a configuration without adding a new component.

Besides, it is possible for the noise detecting unit 32 to detect the noise which has no relation to the driving state of the vehicle, and therefore, the control taking along with a current state becomes possible. For example, when the noise around the vehicle is large and the air supply amount into the interior of the vehicle is large even though the vehicle stops, the rotation speed upper limit value of the electric compressor 22 is set high as same as during driving, and therefore, it becomes possible to increase the effect of the cooling.

### Example 2

FIG. 3 to FIG. 6 are views illustrating an example 2 according to the present invention.

In the following examples, the same reference numerals are used for the same functions as the example 1 to describe.

Characteristics of the example 2 exist in the following points. The rotation speed upper limit value of the electric compressor 22 is determined not by the two-dimensional matrix of the vehicle speed (for example, five levels of the vehicle speed) and the user's air conditioning request but by the rotation speed upper limit value (temporary) of the electric compressor 22 determined by the vehicle speed (for example, the five levels of vehicle speed) and a constant of the rotation speed of the electric compressor 22 found by uniform adaptation and so on in accordance with the user's air conditioning request. Specifically, the air conditioning controlling unit 27 adds each of the constants (A1 to A5) of the rotation speed of the electric compressor 22 to each of the rotation speed upper limit values (temporary) (N1 to N5) of the electric compressor 22, and sets addition results thereof to be the rotation speed upper limit values (N1, N1+A1 to N1+A5, N2, N2+A1 to N2+A5, N3, N3+A1 to N3+A5, N4, N4+A1 to N4+A5, N5, N5+A1 to N5+A5) of the electric compressor 22.

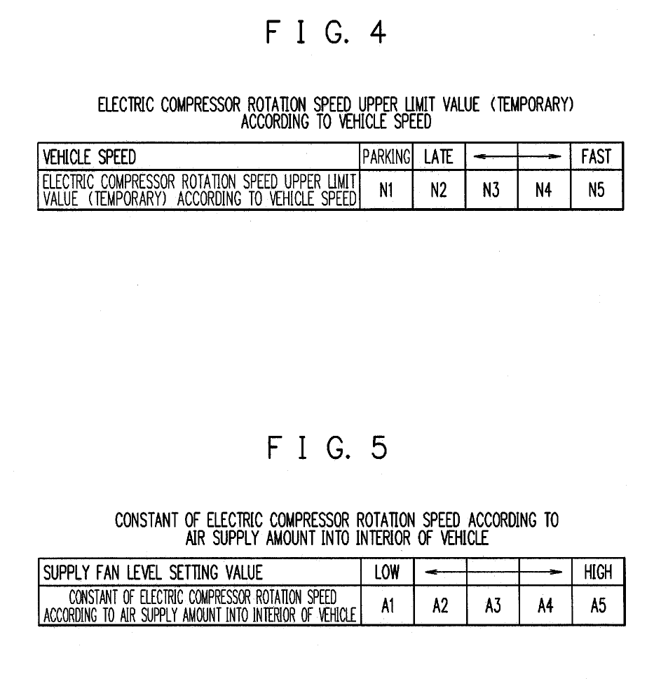

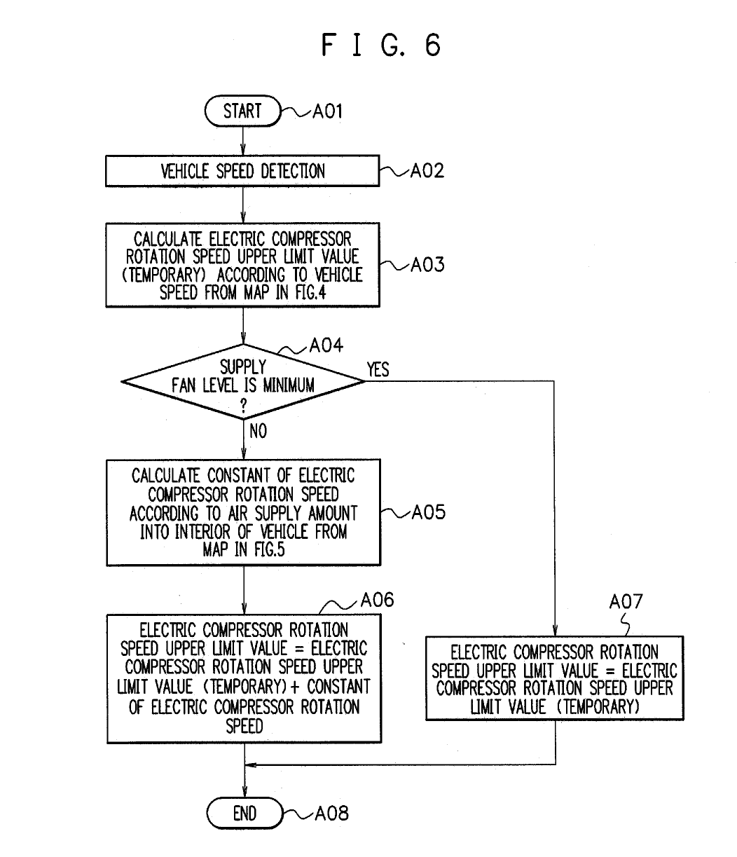

In this case, the rotation speed upper limit values (temporary) (N1 to N5) of the electric compressor 22 are calculated from a map illustrated in FIG. 4. Besides, the constants (A1 to A5) of the rotation speed of the electric compressor 22 found by the uniform adaptation and so on in accordance with the user's air conditioning request are calculated from a map illustrated in FIG. 5.

Here, there is a relationship in which N1≦N2≦N3≦N4≦N5, A1≦A2≦A3≦A4≦A5.

Next, a case when the rotation speed upper limit value of the electric compressor 22 is calculated by adding the constant of the rotation speed of the electric compressor 22 according to the air supply amount into the interior of the vehicle to the rotation speed upper limit value (temporary) of the electric compressor 22 according to the vehicle speed is described based on a flowchart in FIG. 6.

As illustrated in FIG. 6, when a program starts (step A01), the vehicle speed detecting unit 37 detects the vehicle speed (step A02). The air conditioning controlling unit 27 calculates the rotation speed upper limit value (temporary) of the electric compressor 22 from the map in FIG. 4 (step A03), and judges whether or not the fan level setting value is the minimum (step A04).

When the step A04 is NO, the air conditioning controlling unit 27 calculates the constant from the map in FIG. 5 (step A05), and determines the rotation speed upper limit value of the electric compressor 22 by adding the constant to the rotation number upper limit value (temporary) (step A06).

On the other hand, when the step A04 is YES, the air conditioning controlling unit 27 determines the rotation speed upper limit value (temporary) as the rotation speed upper limit value of the electric compressor 22 (step A07).

After the process of the step A06, or the process of the step A07, the program ends (step A08).

In the example 2, it is thereby possible to obtain the similar operation and effect as the example 1. Besides, a memory area required for the air conditioning controlling unit 27 can be reduced. Namely, the air conditioning controlling unit 27 may have the memory area capable of storing total of 10 pieces of data including the five rotation speed upper limit values (temporary) (N1 to N5) of the electric compressor 22 and the five constants (A1 to A5) of the rotation speed of the electric compressor 22 in the example illustrated in FIG. 3. On the other hand, the memory area storing all of the rotation speed upper limit values of the electric compressor (for example, 30 pieces of data) is required in the example 1.

### Example 3

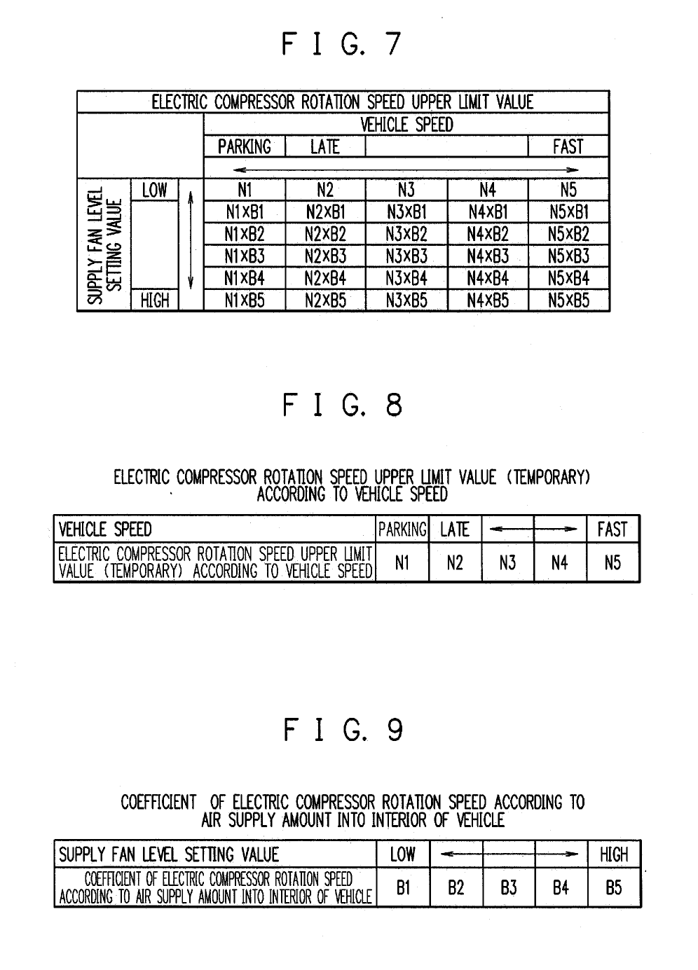

FIG. 7 to FIG. 10 are views illustrating an example 3 according to the present invention.

Characteristics of the example 3 exist in the following points. Namely, the rotation speed upper limit value of the electric compressor 22 is determined not by the two-dimensional matrix of the vehicle speed (for example, the five levels of the vehicle speed) and the user's air conditioning request but by the rotation speed upper limit value (temporary) of the electric compressor 22 determined by the vehicle speed (for example, the five levels of the vehicle speed) and a coefficient of the rotation speed of the electric compressor 22 found by the uniform adaptation and so on in accordance with the user's air conditioning request as illustrated in FIG. 7. Specifically, the air conditioning controlling unit 27 multiplies each of the coefficients (B1 to B5) of the rotation speed of the electric compressor 22 with each of the rotation speed upper limit values (temporary) (N1 to N5) of the electric compressor 22, and determines the rotation speed upper limit values (N1, N1×B1 to N1×B5, N2, N2×B1 to N2×B5, N3, N3×B1 to N3×B5, N4, N4×B1 to N4×B5, N5, N5×B1 to N5×B5) of the electric compressor 22.

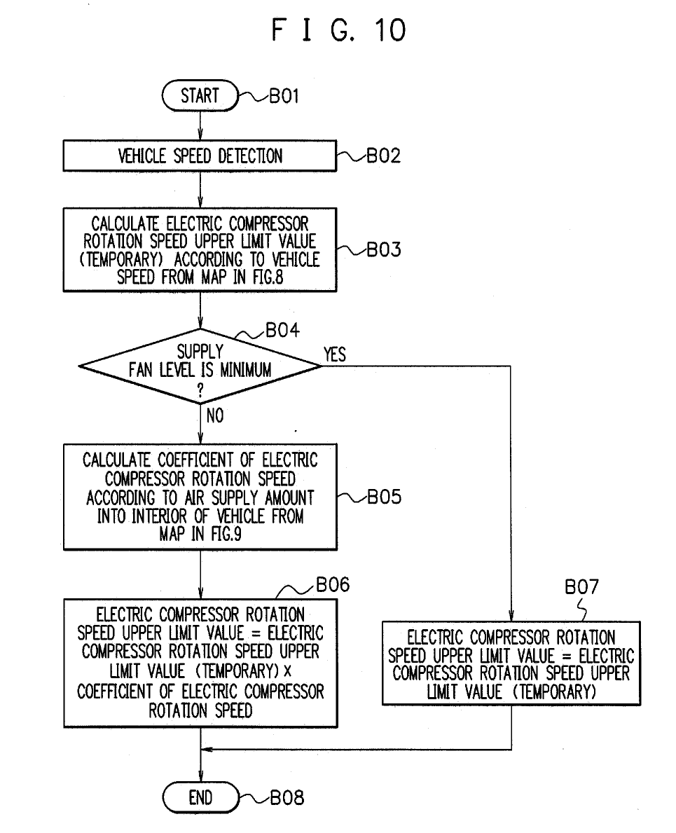

In this case, the rotation speed upper limit values (temporary) (N1 to N5) of the electric compressor 22 are calculated from a map illustrated in FIG. 8. Besides, the coefficients (B1 to B5) found by the uniform adaptation and so on in accordance with the user's air conditioning requests are calculated from a map illustrated in FIG. 9.

Here, there is a relationship where N1≦N2≦N3≦N4≦N5, B1≦B2≦B3≦B4≦B5.

Next, a case when the rotation speed upper limit value of the electric compressor 22 is calculated by multiplying the coefficient of the rotation speed of the electric compressor 22 according to the air supply amount into the interior of the vehicle with the rotation speed upper limit value (temporary) of the electric compressor 22 according to the vehicle speed is described based on a flowchart in FIG. 10.

As illustrated in FIG. 10, when a program starts (step B01), the vehicle speed detecting unit 37 detects the vehicle speed (step B02). The air conditioning controlling unit 27 calculates the rotation speed upper limit value (temporary) of the electric compressor 22 from the map in FIG. 8 (step B03), and judges whether or not the fan level setting value is the minimum (step B04).

When the step B04 is NO, the air conditioning controlling unit 27 calculates the coefficient from the map in FIG. 9 (step B05), and determines the rotation speed upper limit value of the electric compressor 22 by multiplying the coefficient with the rotation number upper limit value (temporary) (step B06).

On the other hand, when the step B04 is YES, the air conditioning controlling unit 27 determines the rotation speed upper limit value (temporary) as the rotation speed upper limit value of the electric compressor 22 (step B07).

After the process of the step B06, or the process of the step B07, the program ends (step B08).

In the example 3, it is thereby possible to obtain the similar operation and effect as the example 1. Besides, the memory area required for the air conditioning controlling unit 27 can be reduced as same as the example 2.

Hereinabove, the embodiments and the examples according to the present invention are described in detail with reference to the drawings, but the present invention is not limited to the embodiments and the examples. Namely, the present invention may be embodied in other specific forms without departing from the spirit or essential characteristics thereof.

### INDUSTRIAL APPLICABILITY

The air conditioner for the vehicle according to the present invention is applicable for various vehicles.

### REFERENCE SIGNS LIST

1 air conditioner
12 supply fan
22 electric compressor
26 controlling unit
27 air conditioning controlling unit
27A electric compressor rotation speed controlling unit
27B fan air supply amount setting unit
27C fan motor rotation speed controlling unit
28 vehicle controlling unit
31 air conditioning operation panel
32 noise detecting unit
33 fan motor rotation speed detecting unit
34 supply fan level setting switch
35 supply air temperature setting switch
37 vehicle speed detecting unit

1. An air conditioner for a vehicle mounting a motor to drive the vehicle, comprising:
a vehicle speed detecting unit detecting a speed of the vehicle;
an electric compressor used for cooling of an interior of the vehicle;
a compressor rotation speed controlling unit controlling a rotation speed of the electric compressor;
a supply fan feeding air cooled by the electric compressor into the interior of the vehicle;
a fan air supply amount setting unit setting an air supply amount of the supply fan; and
a controlling unit setting a rotation speed upper limit value of the electric compressor controlled by the compressor rotation speed controlling unit when the vehicle speed detected by the vehicle speed detecting unit is a predetermined speed or less,
wherein the controlling unit sets the rotation speed upper limit value of the electric compressor based on the vehicle speed detected by the vehicle speed detecting unit and the air supply amount set by the fan air supply amount setting unit.

2. The air conditioner for the vehicle according to claim 1, further comprising:
a fan motor rotation speed controlling unit controlling a rotation speed of a fan motor driving the supply fan,
wherein the controlling unit sets the rotation speed upper limit value of the electric compressor based on the vehicle speed detected by the vehicle speed detecting unit and the rotation speed of the fan motor controlled by the fan motor rotation speed controlling unit.

3. The air conditioner for the vehicle according to claim 1, further comprising:
a fan motor rotation speed detecting unit detecting a rotation speed of a fan motor driving the supply fan,
wherein the controlling unit sets the rotation speed upper limit value of the electric compressor based on the vehicle speed detected by the vehicle speed detecting unit and the rotation speed of the fan motor detected by the fan motor rotation speed detecting unit.
